(19) United States
(12) Patent Application Publication
(10) Pub. No.: US 2006/0238662 A1
(43) Pub. Date: Oct. 26, 2006

(54) Television shelf for audio/video components

(76) Inventors: Sean McGivern, Glen Carbon, IL (US); Peter Pace, Maryville, IL (US); Scott Bots, Chicago, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/082,266

(22) Filed: Mar. 17, 2005

(51) Int. Cl. H04N 5/64

(52) U.S. Cl. 348/836

(57) ABSTRACT

A shelving unit is provided to be mounted on a television, such as a rear projection television, to enable a consumer to position audio/visual components on the television. The shelving unit comprises a mounting member adapted to be secured to a vertical wall extending from the back of the television housing's top surface or deck, a shelf securable to the mounting member to extend rearwardly from the television's vertical wall, and a leg member extending downwardly from the shelf and having a bottom end which engages the television sloped surface. The leg member has a length sufficient to maintain the shelf in a generally horizontal position. The mounting member is positioned on the television vertical wall such that the shelf is supported below the level of the television deck, and such that that audio/visual equipment can be operated either by its respective remote control or by control buttons on the audio/visual equipment.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This application relates to shelves for audio/video equipment and/or components (such as VCR's, DVD players, cable and satellite boxes, stereo equipment, etc.) and in particular to a shelf which can be mounted to a television to stably position the audio/visual equipment on the television.

Consumers are obtaining ever more audio/video components or equipment for use with their TV's. This includes equipment such as VCR's, DVD players and recorders, cable and satellite boxes, and stereo equipment. As services available from various providers expand, it is likely that more equipment will be developed for use in conjunction with televisions.

Consumers typically like to mount their audio/video equipment in close proximity to the television, and preferable on top of the television. For televisions having a traditional tube, the top surface of the television is fairly deep, and audio/video components can be placed directly on top of the TV. However, with the increasing availability of rear projection televisions, such as LCD and DLP televisions, televisions have become quite narrow. Hence, the top surface or deck of the television is substantially narrower. In most of these LCD and DLP rear projection televisions, the top surface of the TV is not sufficiently deep to place audio/video components on the television. In fact, in some instances, the TV deck is only a few inches deep.

It would be desirable to provide a shelf which can be used in conjunction with such televisions to enable consumers to place their audio/video components in close proximity to their TV's without the need to invest in expensive cabinetry.

### BRIEF SUMMARY OF THE INVENTION

Briefly stated, a shelving unit is provided to be mounted on a television, such as a rear projection television, to enable a consumer to position audio/visual components (such as VCRs, DVD players and recorders, stereo equipment, cable and satellite boxes, etc.) on the television. Televisions have a housing having a top deck extending rearwardly from a front of the housing, a vertical wall extending downwardly from a back edge of the top deck, and a sloped surface extending downwardly and rearwardly from a bottom edge of the vertical surface.

In an illustrative embodiment, the shelving unit comprising a mounting member adapted to be secured to the television's vertical wall, a shelf securable to the mounting member to extend rearwardly from the television's vertical wall, and a leg member extending downwardly from the shelf and having a bottom end which engages the television sloped surface. The leg member has a length sufficient to maintain the shelf in a generally horizontal position. The mounting member is positioned on the television vertical wall such that the shelf is supported below the level of the television deck, and such that that audio/visual equipment can be operated either by its respective remote control or by control buttons on the audio/visual equipment.

The mounting member comprises a clip member. The clip member can be separate from, or integral with, the television. In the former instance, the clip member can comprise a plurality of separate clips, each of which is securable to the television's vertical wall. or an elongate strip having a plurality of spaced apart clips thereon. The clip member includes a generally unshaped clip body having an opening at a top thereof which opens into a channel.

The shelf comprises a forward edge member adapted to be received by the clip member. In the illustrative embodiment, the shelf is a wire shelf having a rod extending along the front and back edges of the shelf and a plurality of generally parallel rods extending between the front and back rods. The front rod is received in the mounting member channel to secure the shelf to the television. The opening into the mounting member channel is narrower than the diameter of the front rod, and hence, the clip members snappingly receive the shelf front rod.

The leg member is an extendable/retractable leg member which is removably connectable to the shelf and securable to the shelf at a desired position between a front and back edge of the shelf. A bracket is provided to secure the leg to the shelf. The bracket comprises a lower member positioned against a lower surface of the shelf and means for securing the lower member to the shelf; the leg extending from the lower member. In an illustrative embodiment, the securing means includes an upper member positionable on an upper surface of the shelf. The upper and lower bracket members are connected together to selectively position the leg on the shelf. The upper member can comprise a plate or a U-shaped member. In the instance when the upper member is a plate, the upper member can be provided with channels sized and shaped to receive the shelf defining rods of the shelf. The lower member can be provided with similar channels. In another alternative, the securing means can comprise the channels on the lower member if the channels are shaped to snappingly receive the wire rods of the shelf.

### BRIEF DESCRIPTION OF THE SEVERAL VIEWS OF THE DRAWINGS

FIG. 1 is a side elevational view of a television with one illustrative embodiment of a shelving unit of the present invention mounted thereto;

FIG. 2 is an enlarged side elevational view taken along circle 2 of FIG. 1 and showing an audio/visual unit (such as a VCR) on the shelf of the shelving unit;

FIG. 3 is an exploded perspective of the shelving unit in conjunction with a television;

FIG. 4 is a perspective view of a mounting member of the shelving unit for mounting the shelf of the shelving unit to the television;

FIG. 5 is an exploded perspective view showing the connection of a leg to the shelf of the shelving unit;

FIG. 6 is an exploded perspective view of the leg of the shelving unit;

FIG. 6A is a perspective view of the leg of the shelving unit having an alternative member for connecting the leg to the shelf of the shelving unit;

FIG. 7 is a perspective view of an alternative mounting member in the form of a clip;

FIG. 8 is a view of the mounting member of FIG. 7 connected to a television; and

FIG. 9 is a view showing a further embodiment of the mounting member, wherein the mounting member is formed integrally with the television.

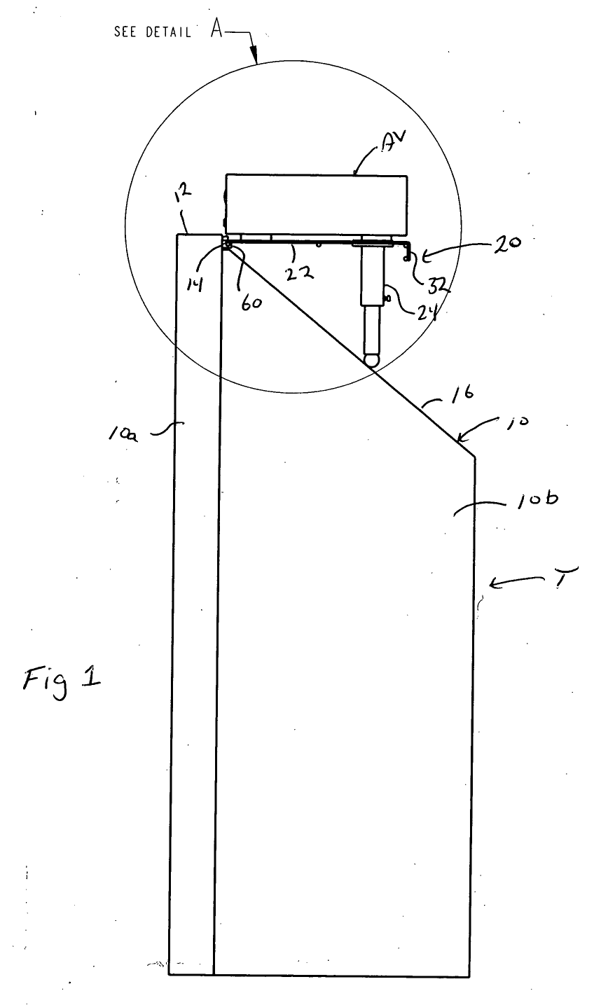

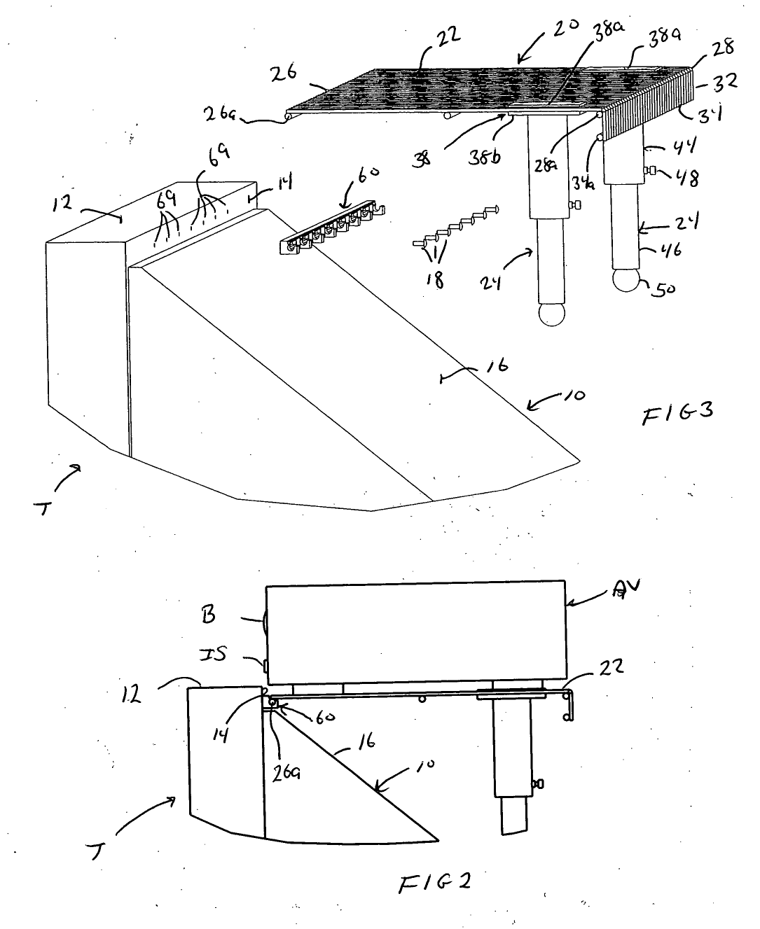

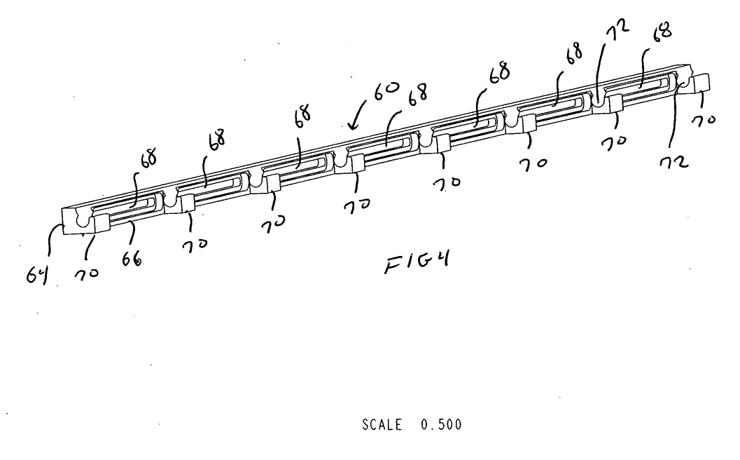

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

A typical television T has a housing 10 which encloses the screen and the electronics for the television. The housing 10 includes a top deck or surface 12 which extends rearwardly from the front surface of the housing 10. A wall 14 extends downwardly from the back of deck 12 a short distance and a sloped 16 surface extends downwardly and rearwardly from the bottom of the vertical wall 14 to the back surface of the television. The housing 10 is divided into a front portion 10a which forms a frame around the television's screen and a back portion 10b which encases the television's electronic components. The front and back portions 10a,b of the housing are connected together in part by a series of screws 18 which extend through the vertical wall 14 at the back of the deck 10.

A shelving unit 20 is provided which can be mounted to the television. The shelving unit comprises a shelf 22 and legs 24. The shelf 22 is shown to be a wire shelf having a forward edge 26, a rear edge 28, and a plurality of surface defining rods 30 extending between the forward and rear edges. In addition, the shelf 22 includes a downwardly extending flange 32 at the back of the shelf. The flange 32 comprises a bottom edge 34 and a plurality of flange defining rods 36 which extend between the flange bottom edge 34 and the shelf back edge 28. The flange defining rods 36 are preferably continuations of the shelf surface defining rods 30. The shelf forward and rear edges 26 and 28 and the flange bottom edge 34 have rods 26a, 28a, and 34a extending transversely to the shelf and flange defining rods 30 and 36. These edge rods have a diameter greater than the surface and flange defining rods. Depending on the depth of the shelf, additional rods can be provided which extend generally perpendicularly to the shelf rods 30 between the front and back edges. As can be appreciated, the shelf 22 can be made from commercially available ventilated wire shelving

The legs 24 are removably connectable to the shelf 22 by means of a mounting bracket 38. The bracket 38 includes an upper member 38a which is positioned above the shelf 22 and a lower member 38b which is positioned below the shelf 22, such that the bracket 38 sandwiches the shelf. The legs 24 extend from the bracket lower member 38b. The two bracket members are connectable together by means of fasteners 39 (such as screws) which extend through the upper bracket member and at least into the lower bracket member. The upper and lower bracket members are provided with holes 37 which receive the fasteners 39. The hole in the upper member 38a can be smooth or threaded, as desired. If the fastener is a bolt, the hole in the bracket lower member is preferably pre-threaded. If the fastener 39 is a screw, the hole in the lower bracket member 38b need not be pre-threaded, and the screw can be threaded into the hole.

The inner or facing surfaces 40 of the upper and lower members 38a,b can be provided with channels 42. The channels 42 are spaced apart a distance corresponding to the spacing between the surface defining rods 30 of the shelf 22 such that the rods 30 will be received in the channels 42. To prevent pivoting of the bracket member about the shelf wires, the bracket members are sized to span the width between at least one pair of wires, such that the bracket will extend across at least two of the shelf wires. The bracket members also include at least two channels 42—there being one channel 42 for each wire the bracket members extend across. The channels 42 thus facilitate positioning of the bracket members on the shelf 22 and for aligning the holes 37 of the upper and lower bracket members 38a,b relative to each other.

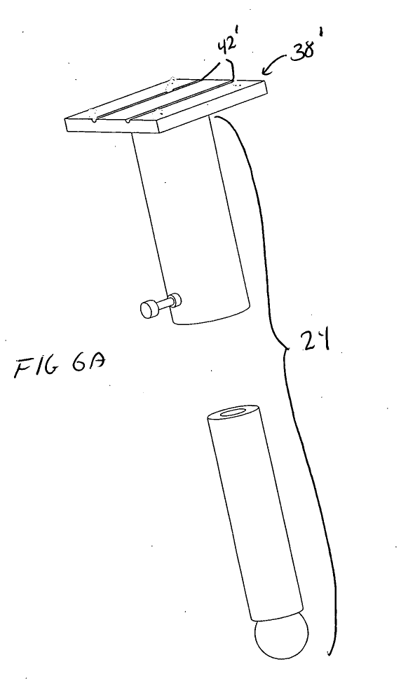

Alternatively, as seen in FIG. 6A, the bracket 38′ can include just a lower member 38b. In this embodiment of the bracket, the channels 42′ in the lower member are shaped to snappingly receive the wires of the shelf 22. To prevent pivoting of the member about the wire, the bracket member 38′ has a width greater than the spacing between the shelf wires and is provided with at a channel 42′ for each wire the bracket extends under. The channels 42′ can be shaped not to snappingly receive the shelf wires. In this instance, the bracket 38′ would be provided with another member, such as a generally U-shaped clip, which connects to the bracket and surrounds the wire. The use of the brackets 38 allows for the legs to be positioned at a desired location between the front and back edges of the shelf 22.

The legs 24 can be extendable/retractable legs, such the length of the leg can be adjusted as necessary. The ability to adjust the length of the leg and the position of the leg enables the shelving unit 20 to be used with televisions having sloping surfaces 16 of different degrees and different lengths. In one embodiment, the legs 24 can comprise an outer member 44 which telescopingly receives an inner member 46. The position of the two members can be held in a desired position relative to each other by means of a set screw 48. In other embodiments, the leg members 44 and 46 can threadedly engage each other, such that the length of the leg 24 is adjusted by rotation of one leg member relative to the other. Other manners known in the art of adjusting the length of the leg 24 can also be used.

The leg 24 includes a foot 50 at the bottom of the leg to engage the sloped surface of the television. In the embodiment shown, the foot 50 comprises a ball which is made of rubber, plastic, or another material having a high coefficient of friction to substantially prevent the foot from sliding relative to the television's sloped surface. The foot 50 could take on other configurations as well. For example, the foot 50 could be a hinged member having a flat bottom surface which rests upon the sloped surface 16 of the television housing 10.

To mount the shelving unit 20 to the television T, the shelf 22 is connected to the vertical wall 14. Preferably, the shelf is connected to the wall 14 below the level of the housing top deck 12 so that the shelf 22 will not be visible from the front of the television T. However, the shelf 22 is sufficiently high, relative to the housing's vertical wall 14, such that the infrared sensor IS of any audio/visual component AV placed directly on the shelf will be above the level of the housing top deck 12, so that the audio/visual component can be operated using a remote control. In addition, the shelf 22 is positioned so that any operating buttons B of the audio/visual equipment will be above the level of the housing top deck 14, so that the audio/visual equipment can be operated by means of the control buttons when desired.

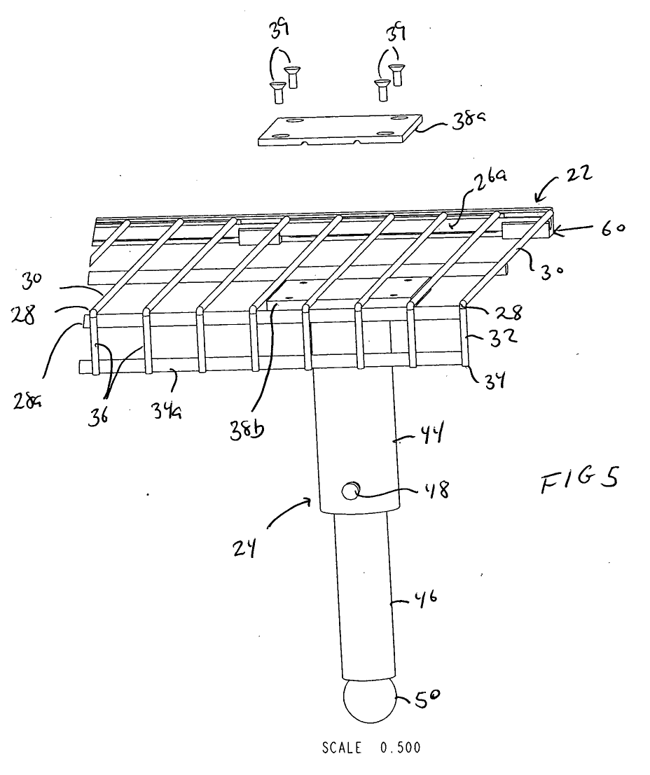

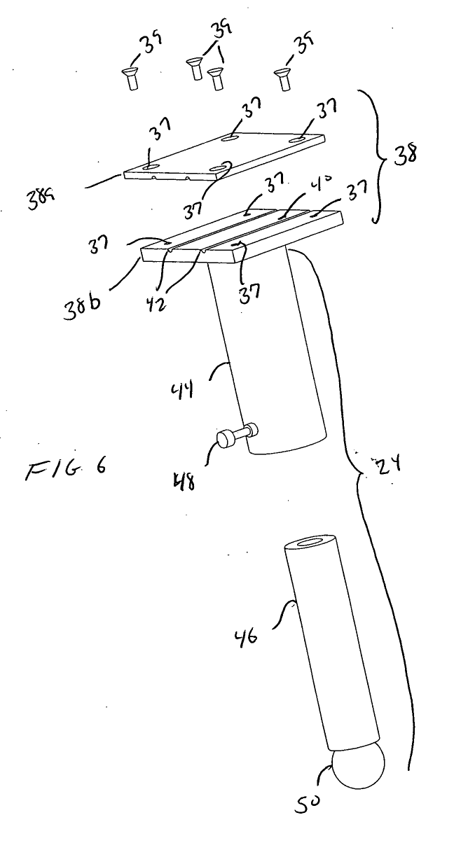

A mounting member 60 to which the shelf 22 is securable is provided to connect the shelf 22 to the television. The mounting member 60, as seen in FIG. 4, comprises a strip 62 having a front surface 64, a back surface 66, a plurality of slots 68 extending between the front and back surfaces, and a plurality of spaced apart clip members 70 extending from a strip back surface 66. The slots 68 are positioned to align with the holes 69 in the television wall 14 which receive screws 18 to hold the housing front and back portions together. Hence, the clip strip 62 is secured to the housing by removing the screws 18 from the housing 10, placing the strip 62 such that the slots 68 are aligned with the screw holes 69, and then reinserting the screws 18 into the housing screw holes 69 through the strip slots 68. The clip members 70, as seen, are positioned between the slots 68 and comprise a generally U-shaped clip having an opening 72 on the top thereof. The U-shaped clip members are sized and shaped to snappingly receive the rod 26 at the forward edge of the shelf 22.

The mounting member strip 60 can have a length substantially equal to the width of the television T. Alternatively, the mounting strip can have a length substantially shorter than the length of the television, and comprise two or more of the clips 70 with the slot 68 therebetween. The strips 60 could, for example, be 3″-12″ in length.

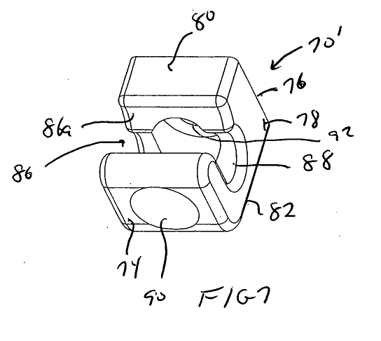

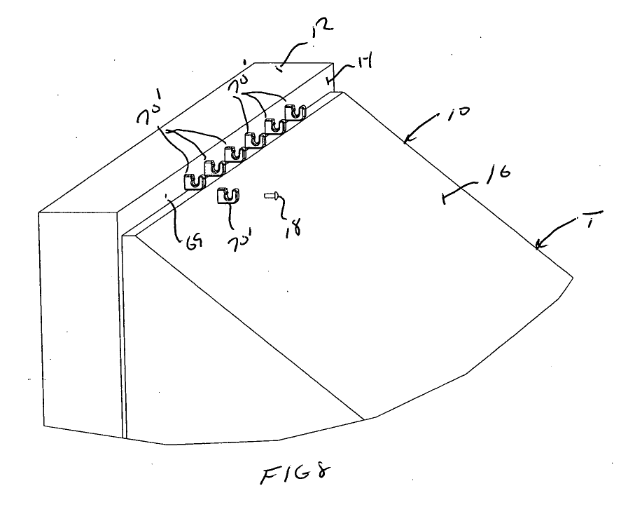

Although the mounting member is shown to comprise a strip containing the clip members, the mounting member can, alternatively comprise independent clips 70′ (FIGS. 7-8). In this instance, the clips 70′ are separately secured to the vertical wall 14 of the television housing 10. As best shown in FIG. 7, the clip 70′ has a rear surface 74, a front surface 76, side surfaces 78, a top surface 80, and a bottom surface 82. An opening 86 in the clip top surface 80 opens in to a channel or groove 88 which extends between the side surfaces 78 of the clip. The groove 88 has a generally curved surface having a diameter sized to receive the front bar 26a at the forward edge 26 of the shelf 22. The back surface 86a of the opening 86 is sloped or beveled to facilitate insertion of the rod or bar 26 into the clip. It will be seen that the groove 88, in end elevation, defines an arc of more than 180°. Hence, the width of the opening 86 at the top of the groove 88 is smaller than the diameter of the rod 26. Thus, the clip deforms slightly as the rod is inserted into the clip, and the clip snappingly receives the rod 26. It will be appreciated that the clip members 70 of the mounting strip 62 are formed substantially similarly to the clip 70′.

The clip 70′ is provided with a screw hole 90 in the rear surface 74 and a corresponding screw hole 92 in the front surface 76 of the clip 70′. As can be seen, the screw holes 90 and 92 are aligned with each other, and define a passage which intersects the groove 88. Screw hole 90 is sized to allow the head of a screw to pass therethrough. Screw hole 92 is countersunk, and includes a portion sized to receive the screw head and a central portion sized to admit the screw shaft. Thus, to mount the clip 70′ to the rear of a television, as seen in FIG. 8, the screw 18 is inserted through screw hole 90 into screw hole 92. The screw shaft is aligned with the screw hole 69 on the back of the television surface 14. The countersunk portion of the screw hole 92 receives the screw head such that the screw will not extend into the clip groove 88. Hence, the screw will not interfere with connection of the shelf 22 to the clip 70′

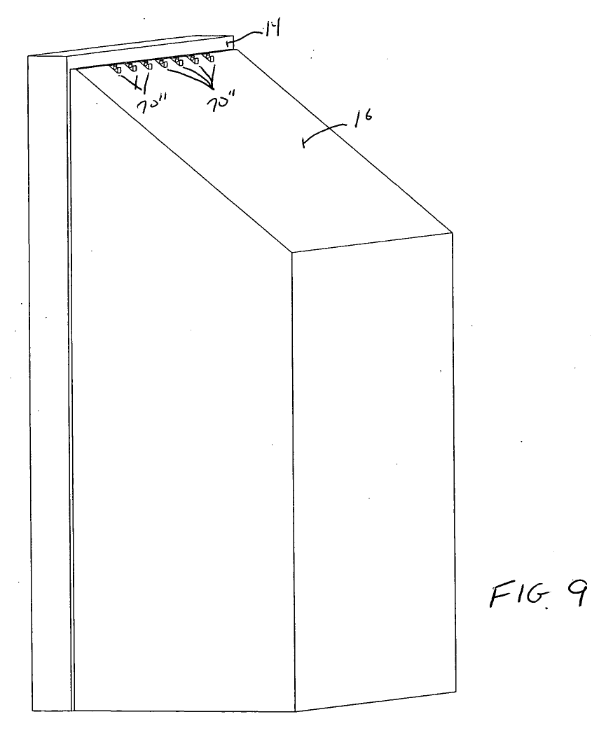

In another alternative, clips 70″ can be molded as part of the television housing, such that the clips 70″ are formed integrally with the housing. As shown in FIG. 9, the clips 70″ are positioned at the base of the vertical wall 14 and extend upwardly from the sloped surface 16 of the television housing. The clips 70″ are substantially similar in shape to the clips 70′. Although shown at the base of the wall 14, the clips 70″ could be positioned higher on the wall 14 if desired.

As a further alternative, the mounting member could comprise a flange extending rearwardly from the housing vertical wall 14 to which the shelf 22 could be secured by fasteners. Such fasteners could include clips, brackets, etc. which secure the shelf to the flange.

In view of the above, it will be seen that we have provided a shelf for audio/visual components. The shelf is positively connected to the television housing, to reduce the possibility of the shelf moving relative off the television. The shelf is positioned on the housing such that the shelf is not visible from the front of the television, but so that the components sitting on the shelf can be operated using their respective remote controls and control buttons.

As various changes could be made in the above constructions without departing from the scope of the invention, it is intended that all matter contained in the above description or shown in the accompanying drawings shall be interpreted as illustrative and not in a limiting sense. For example, although shown to be upwardly opening, the clip members could open rearwardly. The shelf 22 could be a solid shelf, rather than a wire shelf. In this instance, the shelf could be provided with a rib positioned to be received in the clip members. These examples are merely illustrative.

1. In combination, a television and a shelving unit mountable to the television;
the television comprising a housing having a top deck extending rearwardly from a front of the housing, a vertical wall extending downwardly from a back edge of the top deck, and a sloped surface extending downwardly and rearwardly from a bottom edge of the vertical surface;
said shelving unit comprising a mounting member on said television vertical wall, a shelf securable to said mounting member and extending rearwardly from said television vertical wall, and a leg member extending downwardly from said shelf and having a bottom end which engages said television sloped surface, said leg member having a length sufficient to maintain said shelf in a generally horizontal position.

2. The combination of claim 1 wherein said mounting member comprises a clip member.

3. The combination of claim 1 wherein said clip member is separate from and securable to said television vertical wall.

4. The combination of claim 3 wherein said clip member comprises a plurality of clips, each clip being securable to said television vertical wall.

5. The combination of claim 3 wherein said clip member comprises an elongate strip; said clip member being adapted to be mountable to said vertical wall and including a plurality of spaced apart clips extending rearwardly from said strip.

6. The combination of claim 2 wherein said shelf comprises a forward edge member adapted to be received by said clip member.

7. The combination of claim 6 wherein said shelf forward edge member comprises a rod.

8. The combination of claim 7 wherein said clip member comprises a generally unshaped clip body having an opening at a top thereof; said clip snappingly receiving said shelf forward edge.

9. The combination of claim 1 wherein said mounting member is positioned on said television vertical wall such that said shelf is supported below the level of said television deck.

10. The combination of claim 1 wherein said leg member is an extendable/retractable leg member.

11. The combination of claim 1 wherein said leg member is removably connectable to said shelf and securable to said shelf at a desired position between a front and back edge of said shelf.

12. A shelving unit mountable to the television to enable the placement of one or more audio/visual components on the television; the shelving unit comprising:
a mounting member adapted to be secured to a wall of said television;
a shelf securable to said mounting member; and
a leg member extending downwardly from said shelf and having a bottom television engaging end, said leg member having a length sufficient to maintain said shelf in a generally horizontal position when said shelving unit is mounted on a television.

13. The shelving unit of claim 12 wherein said mounting member comprises a clip member.

14. The shelving unit of claim 13 wherein said clip member comprises a plurality of clips, each clip being securable to said television vertical wall.

15. The shelving unit of claim 13 wherein said clip member comprises a strip having a plurality of spaced apart clips extending rearwardly from said strip.

16. The shelving unit of claim 12 wherein said shelf comprises a forward edge member adapted to be received by said clip member.

17. The shelving unit of claim 16 wherein said shelf forward edge member comprises a rod.

18. The shelving unit of claim 17 wherein said clip member comprises a generally unshaped clip body having an opening at a top thereof; said clip snappingly receiving said shelf forward edge.

19. The shelving unit of claim 12 wherein said leg member is an extendable/retractable leg member.

20. The shelving unit of claim 12 wherein said leg member is removably connectable to said shelf and securable to said shelf at a desired position between a front and back edge of said shelf.

21. The shelving unit of claim 20 including a bracket selectively positionable on said shelf; said bracket including a lower member positioned against a lower surface of said shelf and means for securing said lower member to said shelf; said leg extending from said lower member.

22. The shelving unit of claim 21 wherein said securing means comprises an upper bracket member positionable on an upper surface of said shelf; said upper and lower bracket members being connected together to selectively position said leg on said shelf.

23. The shelving unit of claim 22 wherein said shelf is a wire shelf having a plurality of generally parallel rods defining said shelf; said bracket upper and lower members each including channels sized and shaped to receive the shelf defining rods of said shelf.
